(19) United States
(12) Patent Application Publication
(10) Pub. No.: US 2003/0185019 A1
(43) Pub. Date: Oct. 2, 2003

(54) Skateboard lighted riser pad

(76) Inventors: Brian Rogers, Spring Valley, CA (US); Shane Fernandez, San Diego, CA (US)

Correspondence Address: John R. Ross, III, Ross Patent Law Office, P.O. Box 2138, Del Mar, CA, 92014, US

(21) Appl. No.: 10/114,838

(22) Filed: Apr. 2, 2002

(51) Int. Cl. F 21W 1 1/02

(52) U.S. Cl. 362/545

(57) ABSTRACT

A lighted riser pad. A light source is attached to a riser pad. A battery is contained within the riser pad and is connected to the light source. An electrical switch controls the flow of electricity from the battery to the light source. In the preferred embodiment, a recharging jack is connected to the riser pad and the battery is a rechargeable battery. In the preferred embodiment, an electrical switch controls the flow of electricity from the recharging jack to the rechargeable battery and from the rechargeable battery to the light source. Also in the preferred embodiment, the light source is a plurality of LEDs. Also, preferably, the riser pad encasing is die-cast 6051 aluminum and the rechargeable battery is preferably a 9-volt rechargeable battery. In the preferred embodiment, the riser pad is mounted to the underside of a skateboard.

The present invention relates to skateboards, and more specifically to lighting systems for skateboards.

### BACKGROUND OF THE INVENTION

Skateboarding is a well known sport that is popular with young people in the United States as well as other countries throughout the world. Typically, a skateboard has two trucks rigidly mounted fore and aft to a board. Two wheels are then rotatably mounted to each truck. A skateboard rider (a.k.a., skateboarder) rides a skateboard by standing on the board and balancing. A skateboard rider can propel himself forward by pushing against the ground with one foot while keeping the other foot on the board.

While the basic design of a skateboard has remained essentially the same, over time improvements and modifications have been made. For example, wheel design has been improved to offer better performance characteristics (i.e., better traction, better speed, etc.). Also, for example, board design has been improved so that boards today are lighter weight and offer greater strength characteristics than in previous years.

In addition to improvements and modifications of the basic components, modern skateboards have been modified to include additional accessories. For example, motorized skateboards are fairly well known.

Another skateboard accessory is the riser pad. Riser pads are designed to raise the skateboard deck an additional distance (usually approximately ⅛ inch-¾ inch) above ground level. The riser pad gives the skateboard rider a more elegant ride and helps prevent wheel bite when larger wheels are being used. Riser pads also will soften the landing when the skateboard rider is performing stunts. Also, riser pads help prevent board breakage.

### Skateboard Lighting Systems

It is known to add various types of lighting systems to skateboards. However, prior art skateboard lighting systems have tended to be relatively cumbersome and unsafe. The prior art systems are such that they interfere with the skateboard rider and are inconvenient to operate and maintain.

What is needed is a better device for providing light for a skateboard.

### SUMMARY OF THE INVENTION

The present invention provides a lighted riser pad. A light source is attached to a riser pad. A battery is contained within the riser pad and is connected to the light source. An electrical switch controls the flow of electricity from the battery to the light source. In the preferred embodiment, a recharging jack is connected to the riser pad and the battery is a rechargeable battery. In the preferred embodiment, an electrical switch controls the flow of electricity from the recharging jack to the rechargeable battery and from the rechargeable battery to the light source. Also in the preferred embodiment, the light source is a plurality of LEDs. Also, preferably, the riser pad encasing is die-cast 6051 aluminum and the rechargeable battery is preferably a 9-volt rechargeable battery. In the preferred embodiment, the riser pad is mounted to the underside of a skateboard.

### BRIEF DESCRIPTION OF THE DRAWINGS

FIGS. 1-5 and 8 show a first preferred embodiment of the present invention.

FIGS. 6-7 show electrical connectivity of the first preferred embodiment.

FIG. 9 shows the first preferred embodiment mounted to a skateboard.

FIG. 10 shows a second preferred embodiment of the present invention.

FIG. 11 shows another preferred embodiment of the present invention.

FIGS. 12 and 13 show another preferred embodiment of the present invention.

FIG. 14 shows another preferred embodiment of the present invention.

FIGS. 15 and 16 shows another preferred embodiment of the present invention.

FIG. 17 shows another preferred embodiment of the present invention.

FIG. 18 shows another preferred embodiment of the present invention.

FIG. 19 shows another preferred embodiment of the present invention.

### DETAILED DESCRIPTION OF THE PREFERRED EMBODIMENTS

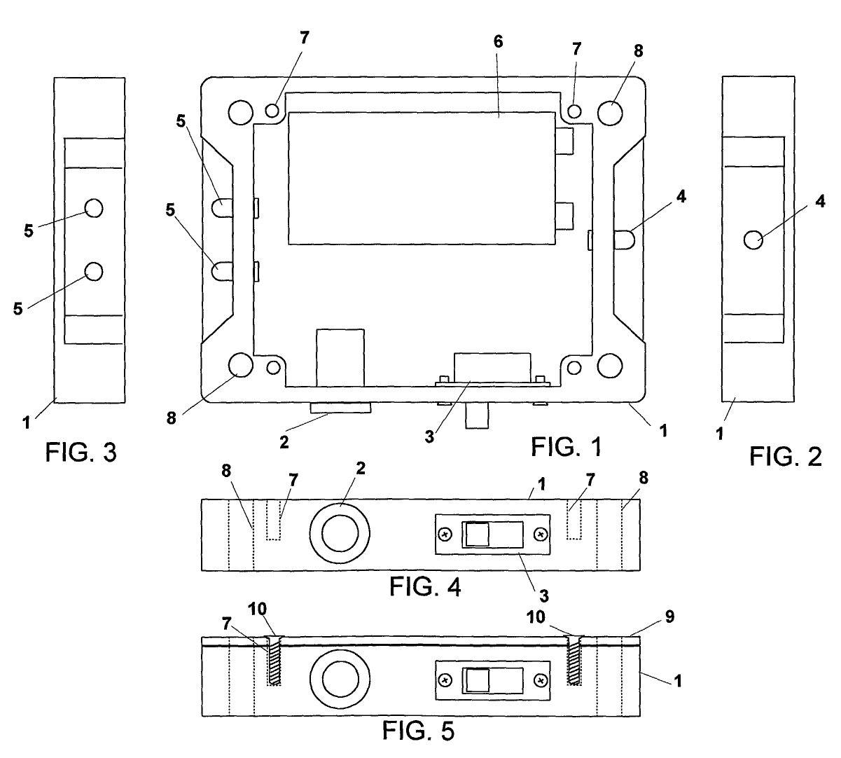

Preferred embodiments of the present invention can be described by reference to FIGS. 1 -19.

First Preferred Embodiment

FIG. 1 shows a top view of the inside of a first preferred riser pad 1 and its components. In the first preferred embodiment riser pad 1 is die-cast from 6051 aluminum and is approximately 3.1 inches long, 2.2 inches wide and 0.6 inches high. FIG. 2 shows a rear view of riser pad 1, FIG. 3 shows a front view of riser pad 1, and FIG. 4 shows a side view of riser pad 1. Recharging jack 2 and switch 3 are both mounted to the side of riser pad 1. Light emitting diode (LED) 4 is mounted to the rear of riser pad 1. In the first preferred embodiment, LED 4 is red. LEDs 5 are mounted to the front of riser pad 1 and in the first preferred embodiment LEDs 5 are white. Battery 6 is mounted inside riser pad 1. In the first preferred embodiment, battery 6 is a 9-volt rechargeable battery. Four mounting holes 8 are drilled through riser pad 1. Also, four threaded holes 7 are drilled approximately half way through riser pad 1. FIG. 5 shows riser pad 1 with riser pad cover 9 securely fastened to the top of riser pad 1 via screws 10.

Electrical Connectivity of the First Preferred Embodiment

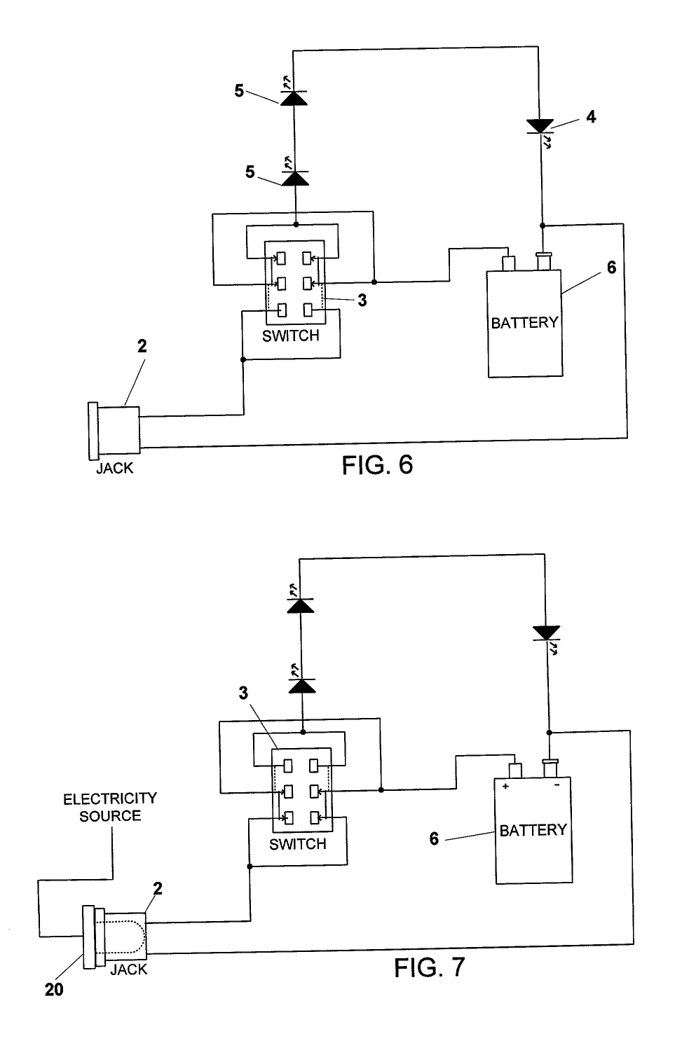

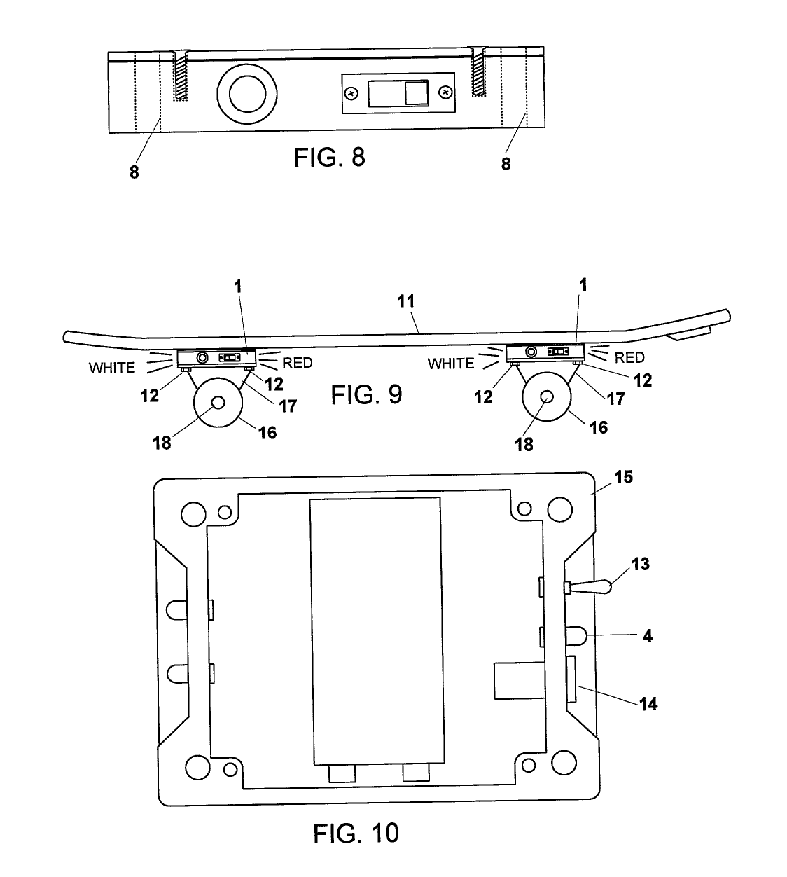

FIG. 6 shows the electrical connectivity of the first preferred embodiment. The flow of electricity is controlled by switch 3. In the first preferred embodiment, switch 3 is a miniature slide switch (Part. No. 10SM002, available from Mouser Electronics and can be ordered from the Mouser Electronics' Web site address at www.mouser.com.). In FIG. 6, switch 3 is in the “on” position. Electricity flows from battery 6 through switch 3 and is directed to LEDs 5 and LED 4. The “on” position of switch 3 is also shown in FIG. 5. In FIG. 7, switch 3 has been moved to the “off” position. The “off” position is also shown in FIG. 8. Electrical plug 20 is connected to a source of electricity. Electrical plug 20 has been inserted into jack 2. Electricity flows from plug 20 and is directed to rechargeable battery 6 through switch 3. After battery 6 has been properly charged, plug 20 can be removed.

Mounting the First Preferred Embodiment

FIG. 9 shows two lighted riser pads 1 mounted to skateboard 11. Wheels 16 are rotatably mounted on axis 18 of trucks 17. Screws 12 are inserted through mounting holes in trucks 17 and through holes 8 (FIG. 8) of riser pads 1. In the first preferred embodiment, LEDs 5 (FIG. 1) are arranged so that the white light is directed forward and LED 4 is arranged so that the red light is directed rearward.

Second Preferred Embodiment

A second preferred embodiment is shown in FIG. 10. In the second preferred embodiment, riser pad 15 has two mounting holes located on both sides of LED 4 in which toggle switch 13 and jack 14 are mounted. Toggle switch 13 replaces slide switch 3 (FIG. 1) and jack 14 replaces jack 2 (FIG. 1), both described above in reference to the first preferred embodiment.

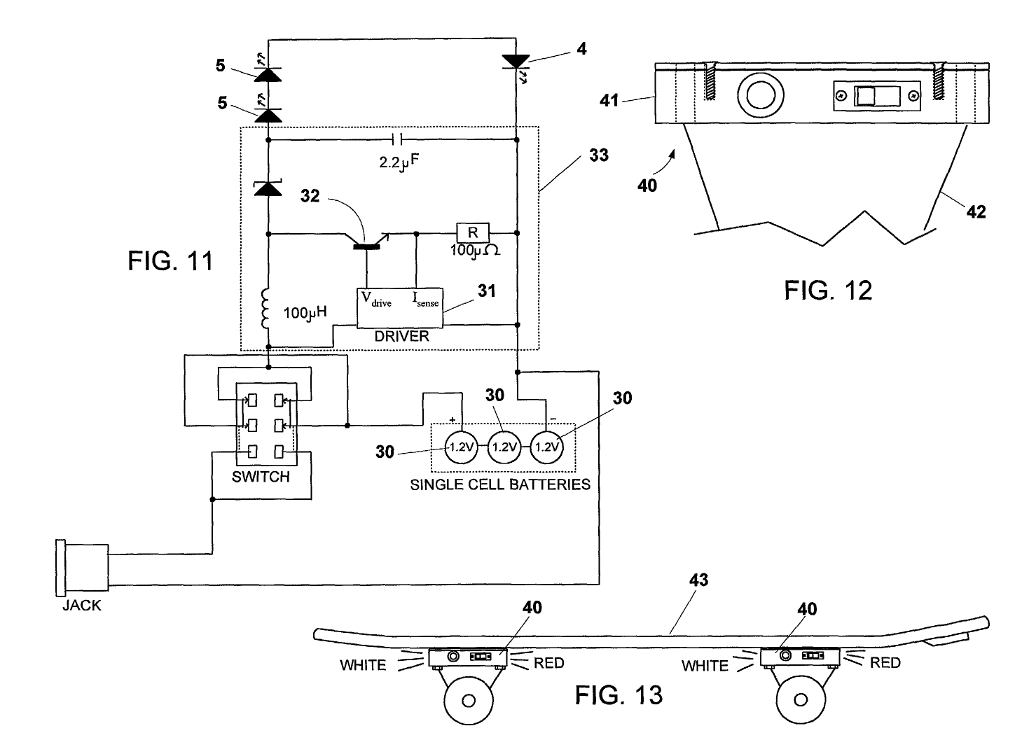

Third Preferred Embodiment A third preferred embodiment is shown in FIG. 11. In the third preferred embodiment, three thin 1.2-volt single cell coin batteries 30 replace 9-volt battery 6 of the first preferred embodiment. By utilizing coin cell batteries 30, pad riser 1 can be much thinner. For example, the as explained above, riser pad 1 is approximately 0.6 inches thick. In contrast, the third embodiment (with thin coin cell batteries 30), is approximately 0.2-0.3 inches thick. A thin riser pad (0.2-0.3 inches) is considered by many skateboard riders to be desirable for shorter skateboards, whereas a thick riser pad (approximately 0.6 inches) is considered by many skateboard riders to be desirable for longer skateboards.

As shown in FIG. 11, the third preferred embodiment includes step-up voltage conversion circuit 33. Step-up voltage conversion circuit 33 has driver 31, which is an LED driver designed for applications where step-up voltage conversion from very low input voltages is required. Preferably, driver 31 is model no. ZXSC300E5 available from ZETEX Semiconductors. Driver 31 drives NPN transistor 32. Step-up voltage conversion circuit 33 converts the 3.6-volt input from coin cell batteries 30 to approximately 8 volts to provide increased voltage to LEDs 4 and 5.

Fourth Preferred Embodiment

A fourth preferred embodiment is shown in FIGS. 12 and 13. In the fourth preferred embodiment, skateboard truck 40 has been machined so that it includes riser pad section 41 permanently attached to lower truck section 42. In the fourth preferred embodiment, it is unnecessary for the skateboard rider to purchase a separate riser pad to attach to his skateboard truck because skateboard truck 40 already has riser pad section 41 built into it. Skateboard truck 40 is able to house the components necessary for providing light in a fashion similar to that described in reference to the above-preferred embodiments. FIG. 13 shows skateboard trucks 40 attached to skateboard 43.

Fifth Preferred Embodiment

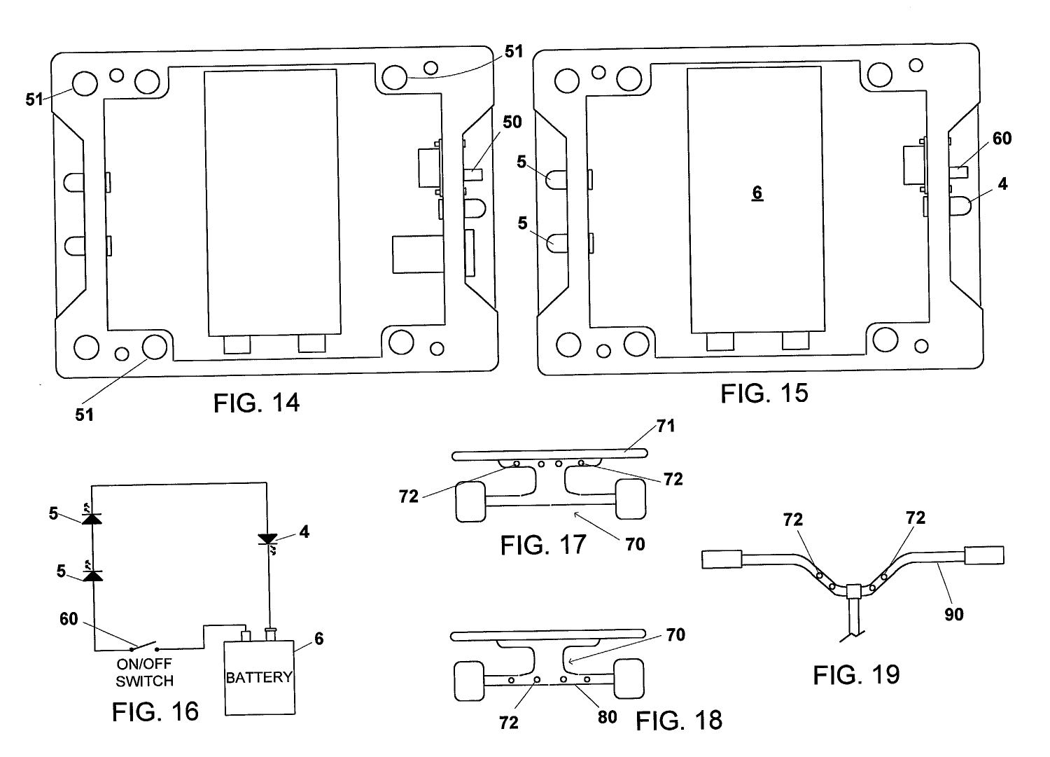

The fifth preferred embodiment is shown in FIG. 14 and is similar to the second preferred embodiment shown in FIG. 10. However, the fifth preferred embodiment includes slide switch 50 in place of toggle switch 13. Also, the fifth preferred embodiment has six mounting holes 51 and battery 6 is oriented as shown.

Sixth Preferred Embodiment

The sixth preferred embodiment is shown in FIG. 15. The sixth preferred differs from the above preferred embodiments in that it does not include a recharging jack. A simple circuit for the sixth preferred embodiment is shown in FIG. 16. Battery 6 powers LEDs 4 and 5. The flow of electricity is controlled by on/off switch 60.

Seventh Preferred Embodiment

A seventh preferred embodiment is shown in FIG. 17. In the seventh preferred embodiment, skateboard truck 70 is mounted to skateboard 71. Battery 6 (FIG. 6) is mounted inside a hollow section of skateboard truck 70. On/off switch 60 (FIG. 6) is mounted to the side of skateboard truck 70 so that it is finger accessible. LEDs 72 are mounted in mounting holes drilled in the upper portion of skateboard truck 70.

Eighth Preferred Embodiment

The eighth preferred embodiment is shown in FIG. 18. The eighth preferred embodiment is similar to the seventh preferred embodiment except that LEDs 72 are mounted mounting holes drilled in skateboard truck axle 80.

Ninth Preferred Embodiment

A ninth preferred embodiment is shown in FIG. 19. The ninth preferred embodiment is similar to the seventh and eighth preferred embodiments. However, FIG. 19 shows LEDs 72 mounted to mounting holes drilled in hollow bicycle handlebars 90. Also, for the ninth preferred embodiment, battery 6 (FIG. 6) is mounted inside bicycle handlebars 90 and on/off switch 60 (FIG. 6) is mounted to the side of bicycle handlebars 90 so that it is finger accessible.

While the above description contains many specifications, the reader should not construe these as limitations on the scope of the invention, but merely as exemplifications of preferred embodiments thereof. Those skilled in the art will envision many other possible variations are within its scope. For example, although it was stated that riser pad 1 was preferably die-cast from 6051 aluminum, a variety of other materials are also possible. For example, riser pad 1 can be fabricated from 7000 series aluminum. Also, although the above preferred embodiments stated that LEDs 5 were white and LED 4 was red a variety of different LED colors can be utilized. LEDs are the preferred light source because of their high durability characteristics and relatively low power requirements. However, it would be possible to substitute other types of light sources for the LEDs. For example, an ordinary miniature flashlight bulb would also be effective. Also, although it was stated above that riser pad 1 is preferably die-cast, it could also be manufactured using other well known techniques, such as machining and plastic injection molding. Also, although the present invention discussed the utilization of the lighted riser pads in conjunction with a skateboard, it could also be attached to other devices. For example, riser pad 1 could be attached to roller skates, inline skates and scooters. Also, although battery 6 was described as being a 9-volt battery, other battery types could also be utilized. Also, a plurality of batteries could be used. For example, battery 6 could be replaced with two AA Batteries or three AAA Batteries. Also, in the fourth preferred embodiment, riser pad section 41 can be permanently attached to lower truck section 4 utilizing a variety of methods besides machining. For example, riser pad section 41 can be welded to lower truck section 42. Or, skateboard truck 40 can be die-cast so that it includes both riser pad section 41 and lower truck section 42 permanently attached. Also, although FIG. 9 shows riser pads 1 arranged so that the white LEDs are pointing left and the red LEDs are pointing right, the red and white LEDs can be otherwise arranged so that they point differently. For example, the white LEDs can be arranged so that they both point to the outside of the skateboard and the red LEDs both point to the middle of the skateboard. Accordingly the reader is requested to determine the scope of the invention by the appended claims and their legal equivalents, and not by the examples which have been given.

We claim:

1) A lighted riser pad, comprising:
A) a riser pad encasing,
B) at least one light source mounted to said encasing,
C) a battery electrically connected to said at least one light source, and
D) an electrical switch for controlling the flow of electricity from said battery to said at least one light source.

2) The lighted riser pad as in claim 1, wherein said battery is a rechargeable battery, said lighted riser pad further comprising:
A) a recharging jack electrically connected to said rechargeable battery, wherein said electrical switch is for controlling the flow of electricity from said recharging jack to said rechargeable battery and for controlling the flow of electricity from said rechargeable battery to said at least one light source.

3) The lighted riser pad as in claim 1, wherein said riser pad encasing is 6051 aluminum.

4) The lighted riser pad as in claim 1, wherein said at least one light source is at least one LED.

5) The lighted riser pad as in claim 2, wherein said rechargeable battery is a rechargeable 9-volt battery.

6) The lighted riser pad as in claim 2, wherein said rechargeable battery is a plurality of rechargeable batteries.

7) The lighted riser pad as in claim 1, wherein said electrical switch is a slide switch.

8) The lighted riser pad as in claim 1, further comprising a step-up voltage conversion circuit for increasing the voltage delivered by said battery.

9) The lighted riser pad as in claim 8, wherein said battery is at least one single cell coin battery.

10) The lighted riser pad as in claim 1, wherein said riser pad is mounted to a skateboard.

11) The lighted riser pad as in claim 1, wherein said riser pad is mounted to a roller skate.

12) The lighted riser pad as in claim 1, wherein said riser pad is mounted to an inline skate.

13) The lighted riser pad as in claim 1, wherein said riser pad is mounted to a scooter.

14) The lighted riser pad as in claim 1, wherein said lighted riser pad further comprises a lower truck section, wherein said riser pad encasing is permanently attached to said lower truck section.

15) A lighted riser pad, comprising:
A) a riser pad encasing means,
B) at least one light source means mounted to said encasing means,
C) a rechargeable battery means electrically connected to said at least one light source means,
D) a recharging jack means electrically connected to said rechargeable battery means, and
E) an electrical switch means for controlling the flow of electricity from said recharging jack means to said rechargeable battery means and for controlling the flow of electricity from said rechargeable battery means to said at least one light source means.

16) The lighted riser pad as in claim 15, further comprising a step-up voltage conversion means for increasing the voltage delivered by said rechargeable battery.

17) The lighted riser pad as in claim 15, wherein said riser pad is mounted to a skateboard means.

18) A lighted skateboard truck, comprising:
A) at least one light source mounted to said skateboard truck,
B) a battery electrically connected to said at least one light source, and
C) an electrical switch for controlling the flow of electricity from said battery to said at least one light source.

19) The lighted skateboard truck as in claim 18, wherein said battery is a rechargeable battery, said lighted skateboard truck further comprising:
A) a recharging jack electrically connected to said rechargeable battery, wherein said electrical switch is for controlling the flow of electricity from said recharging jack to said rechargeable battery and for controlling the flow of electricity from said rechargeable battery to said at least one light source.
